(19) United States
(12) Patent Application Publication
(10) Pub. No.: US 2025/0332850 A1
(43) Pub. Date: Oct. 30, 2025

(54) RECORDING APPARATUS

(71) Applicant: CANON KABUSHIKI KAISHA, Tokyo (JP)

(72) Inventors: MASAKI TAKESHIMA, Kanagawa (JP); TOSHINOBU TOKITA, Kanagawa (JP)

(21) Appl. No.: 19/187,754

(22) Filed: Apr. 23, 2025

(30) Foreign Application Priority Data
Apr. 25, 2024 (JP) 2024-071972

(51) Int. Cl. B41J 13/10; B41J 11/00; B41J 13/076; B41J 13/24

(52) U.S. Cl. CPC B41J 13/106; B41J 11/002; B41J 13/076; B41J 13/24

(57) ABSTRACT

To reduce recorded matter damage associated with deformation of a recording medium, a recording apparatus includes a conveyance unit configured to convey a recording medium, a recording head configured to record an image by ejecting ink to the recording medium conveyed by the conveyance unit, a fixing unit configured to fix the ink onto the recording medium on which recording has been performed by the recording head, a sheet discharge guide disposed opposite the fixing unit and configured to support the recording medium, and a holding-down unit disposed between the fixing unit and the sheet discharge guide and configured to hold down the recording medium.

### BACKGROUND

### Field

The present disclosure relates to a recording apparatus.

### Description of the Related Art

U.S. Pat. No. 9,849,695 discusses a fixing unit that fixes emulsion ink onto a recording medium in an inkjet recording apparatus. FIG. 7 illustrates a fixing unit 5100 discussed in U.S. Pat. No. 9,849,695. A fan 5102 and a heater 5103 are used to generate warm air in a chamber 5101. The warm air is sprayed toward a sheet passing surface 5007 from a pattern hole 5101a on a bottom face of the chamber 5101. The bottom face of the chamber 5101 is arranged opposite the sheet passing surface 5007. A recording medium conveyed to the sheet passing surface 5007 receives the warm air from the pattern hole 5101a, and the ink which has been provided to the recording medium is dried and fixed onto the recording medium.

In general, however, if a recording medium is heated by, for example, warm air, thermal deformation may occur. In a case where the apparatus is designed to have a smaller gap between the bottom face of the chamber 5101 and the sheet passing surface 5007 to acquire higher drying efficiency, a thermally deformed recording medium contacts the bottom face of the chamber 5101. Such contact may damage the recorded matter.

### SUMMARY

The present disclosure has been made in view of the aforementioned issues, and is directed to reduction of recorded matter damage associated with deformation of a recording medium.

According to some embodiments, a recording apparatus includes a conveyance unit configured to convey a recording medium, a recording head configured to record an image by ejecting ink to the recording medium conveyed by the conveyance unit, a fixing unit configured to fix the ink onto the recording medium on which recording has been performed by the recording head, a sheet discharge guide disposed opposite the fixing unit and configured to support the recording medium, and a holding-down unit disposed between the fixing unit and the sheet discharge guide and configured to hold down the recording medium.

Further features of the present disclosure will become apparent from the following description of exemplary embodiments with reference to the attached drawings.

### BRIEF DESCRIPTION OF THE DRAWINGS

FIG. 1 is a perspective view illustrating an outer appearance of a recording apparatus according to a first exemplary embodiment.

FIGS. 2A and 2B are side sectional views each schematically illustrating the recording apparatus according to the first exemplary embodiment.

FIGS. 3A and 3B are diagrams each illustrating a sheet holding-down configuration of the recording apparatus according to the first exemplary embodiment.

FIG. 4 is a diagram illustrating a sheet holding-down configuration of a recording medium according to a modification of the first exemplary embodiment.

FIGS. 5A through 5D are diagrams each illustrating a sheet holding-down configuration of a recording apparatus according to a second exemplary embodiment.

FIGS. 6A through 6C are diagrams each illustrating a sheet holding-down configuration of a recording apparatus according to a third exemplary embodiment.

FIG. 7 is a diagram illustrating a related art technique.

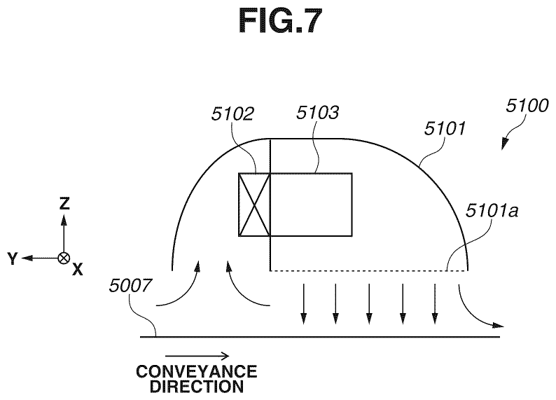

### DESCRIPTION OF THE EMBODIMENTS

Hereinafter, various exemplary embodiments, features, and aspects of the present disclosure are described with reference to the drawings. However, it is to be understood that each of the exemplary embodiments described below is not intended to limit the present disclosure, and that not all of combinations of aspects that are described in the exemplary embodiment are necessary for an issue to be solved by the present disclosure. Relative arrangements and shapes of components described in each of the exemplary embodiments are illustrative only, and the descriptions of the exemplary embodiments are not intended to limit the scope of the disclosure.

The term “record” or “recording” used in the present disclosure represents not only a case where meaningful information such as text and a graphic is formed, but also a case where an image, a design, or a pattern is formed on a recording medium regardless of whether it is meaningful or meaningless information, or a case where a recording medium is processed. It does not matter whether the resultant of “record” or “recording” is visually perceived by human. In each of the exemplary embodiments, paper is considered as “a document” or “a recording medium”. However, cloth, a plastic film (e.g., an overhead projector (OHP) film), a metal plate, glass, ceramic, wood, or leather may be used.

The term “ink” (may also be referred to as “liquid”) used in the present disclosure should be broadly interpreted as similar to the definition of “record” or “recording” described above. Hence, the term “ink” represents liquid that is provided to a recording medium, so that an image, a design, or a pattern is formed, or a recording medium is processed. Alternatively, the term “ink” represents liquid that is supplied in an ink process (e.g., coagulation or insolubilization of a colorant in ink to be provided to a recording medium).

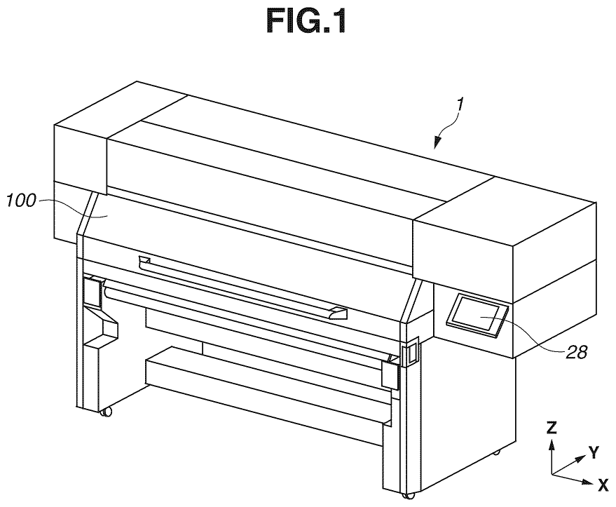

Hereinafter, a configuration of a recording apparatus 1 according to an exemplary embodiment is described with reference to FIG. 1. The recording apparatus 1 performs printing by an inkjet method. FIG. 1 is a perspective view illustrating an outer appearance of the recording apparatus 1 in a state in which a fixing unit 100 that fixes ink onto a recording medium is set in a fixing position. The recording apparatus 1 includes an operation panel 28 that receives an operation performed by a user. The operation panel 28 is connected via an input interface to a control unit that comprehensively controls the recording apparatus 1.

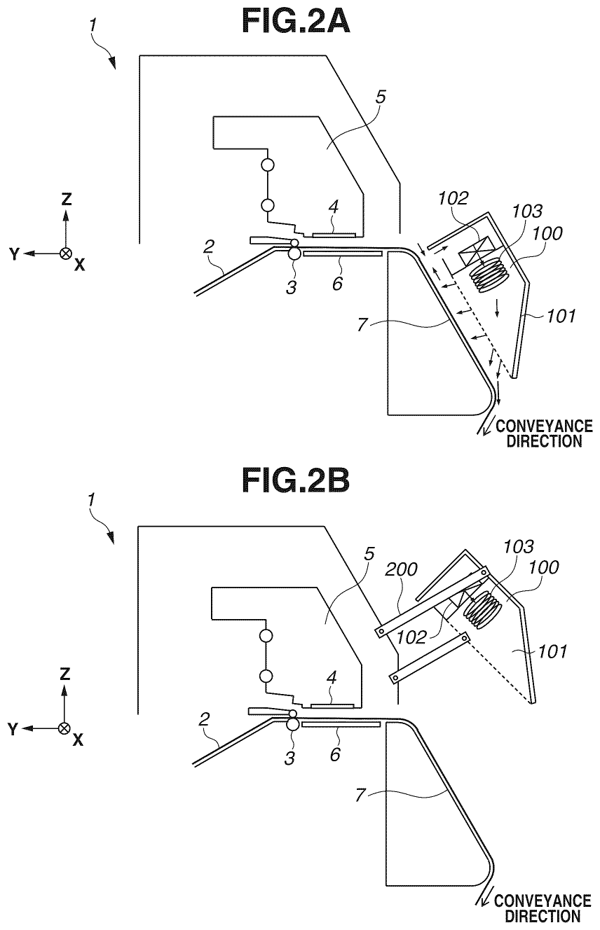

FIG. 2A is a side sectional view schematically illustrating the recording apparatus 1. In the description of the present exemplary embodiment, the recording apparatus 1 ejects emersion ink. However, the type of ink is not limited to the emersion ink. A recording medium 2 is an ink absorption medium such as paper or an ink non-absorption medium such as vinyl chloride. A conveyance unit 3 conveys the recording medium 2 in a conveyance direction illustrated in FIG. 2A. The conveyance unit 3 includes, for example, a pinch roller. The recording apparatus 1 employs a roll-to-roll method in which rollers (not illustrated) around which a recording medium 2 of long continuous paper (roll paper) is wound before and after recording by a recording head 4 are different from each other. However, the method for conveying the recording medium 2 according to the present exemplary embodiment is not limited thereto. For example, a method for conveying a recording medium 2 of cut paper (flat paper) may be employed.

The recording head 4 is mounted on a carriage 5. The recording head 4 ejects ink to the recording medium 2 while the carriage 5 is scanning in an X direction. When the ejection of ink for one scanning or multiple scanning performed by the carriage 5 is finished, the recording medium 2 is conveyed in the conveyance direction for a predetermined distance by the conveyance unit 3. Accordingly, the ink ejection operation by the recording head 4 and the intermittent conveyance operation by the conveyance unit 3 are repeated, so that an image is formed on the recording medium 2.

A platen 6 is disposed opposite an ejection surface of the recording head 4, and supports a back surface of the recording medium 2 conveyed by the conveyance unit 3. The platen 6 of the present exemplary embodiment has a suction port to prevent the recording medium 2 from floating, and a suction source such as a suction fan is driven to perform suction from the suction port, thereby absorbing the recording medium 2 to a supporting surface of the platen 6. A sheet discharge guide 7 is disposed opposite the fixing unit 100 which fixes (dries) ink of the recording medium 2 on which the recording has been performed by the recording head 4. The sheet discharge guide 7 supports a back surface of the recording medium 2.

Next, a configuration of the fixing unit 100 is described. The fixing unit 100 is disposed downstream of the recording head 4 in the conveyance direction. The fixing unit 100 dries the ink provided to the recording medium 2 to fix the ink onto the recording medium 2. The fixing unit 100 sprays warm air generated by a fan 102 and a heater 103 toward the recording medium 2 from a bottom face of a chamber 101 having a substantially box shape.

The bottom face of the chamber 101 faces the recording medium 2 and the sheet discharge guide 7 which guides the recording medium 2. Since temperature of the ink and the recording medium 2 to which the warm air is sprayed increases, water and solvent in the ink evaporate, and emulsion becomes a film. Thus, the ink is fixed onto the recording medium 2. The configuration of the fixing unit 100 is not limited thereto. The fixing unit 100 may not include the heater 103. In such a case, the fixing unit 100 simply blows air. Alternatively, the fixing unit 100 may not include the fan 102. In such a case, the fixing unit 100 simply heats a recording medium 2.

FIG. 2B illustrates a state after the fixing unit 100 is moved to a retracted position from a fixing position. The recording apparatus 1 includes a linking mechanism 200 to retract the fixing unit 100 from the sheet discharge guide 7 (to move the fixing unit 100 to a retracted position) when a user sets a recording medium 2 or clears a jammed recording medium 2.

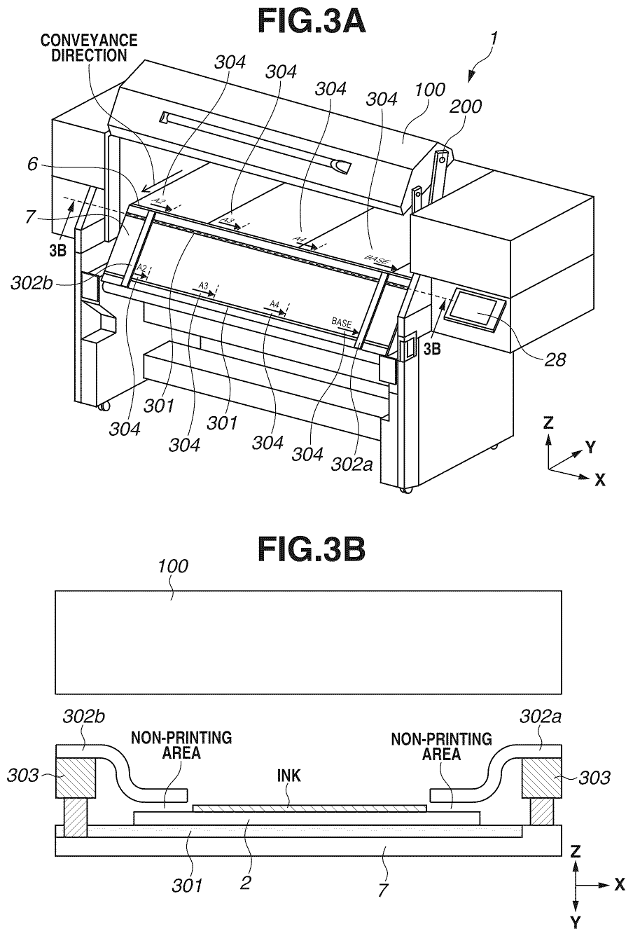

A sheet holding-down configuration by which a recording medium 2 that has been thermally deformed can be held down according to the present exemplary embodiment is described with reference to FIGS. 3A and 3B. FIG. 3A is a perspective view illustrating a state in which the fixing unit 100 is in a retracted position in which the fixing unit 100 is lifted upward by the linking mechanism 200. The recording apparatus 1 includes holding-down plates 302a and 302b by which the recording medium 2 supported by the sheet discharge guide 7 is held down from above, and a holding-down guide 301 that guides the holding-down plates 302a and 302b. The holding-down guide 301 is securely disposed on each of an upstream side (an upper side) and a downstream side (a lower side) of the sheet discharge guide 7 in the conveyance direction along an X direction (a width direction of the recording medium 2).

The recording apparatus 1 includes a holding-down plate 302a extending in the conveyance direction to hold down one end of the recording medium 2 in the X direction, and a holding-down plate 302b extending in the conveyance direction to hold down the other end of the recording medium 2 in the X direction. Each of the holding-down plates 302a and 302b extends in the conveyance direction such that the holding-down plates 302a and 302b bridge the two holding-down guides 301 which are respectively arranged upstream and downstream in the conveyance direction. The holding-down plate 302a is securely disposed on the right side (a side close to the operation panel 28) when viewed from the front of the recording apparatus 1. On the other hand, the holding-down plate 302b is configured to be slidable in an X axis direction along the holding-down guide 301.

FIG. 3B is a schematic sectional view of the recording apparatus 1 along the broken line 3B-3B of FIG. 3A, as seen from the conveyance direction. A gap between the holding-down plate 302a and the sheet discharge guide 7 and a gap between the holding-down plate 302b and the sheet discharge guide 7 are set to size that enables the recording medium 2 to pass through. Each of the holding-down plates 302a and 302b holds down an end portion (an edge) of the recording medium 2 in the X direction, that is, a non-printing area of the recording medium 2 (an area on which recording by the recording head 4 is not performed).

The edge of the recording medium 2 is held by the holding-down plates 302a and 302b, so that the recording medium 2 and the ink provided to the recording medium 2 are prevented from contacting the fixing unit 100 even in a case where the recording medium 2 is curled due to thermal deformation. Moreover, since the holding-down plate 302b is configured to be slidable, a holding-down position can be changed depending on a width of the recording medium 2. Such a configuration enables the recording medium 2 to be appropriately held down regardless of the size of the recording medium 2.

The recording apparatus 1 has a configuration in which the holding-down plate 302a is securely disposed since a recording medium 2 is conveyed with an end thereof aligned with the right end portion of the recording apparatus 1 in the X direction. However, the configuration of the recording apparatus 1 is not limited thereto. The holding-down plate 302a may also be slidable along the holding-down guide 301. The holding-down guide 301 is securely disposed to the sheet discharge guide 7 as described in the present exemplary embodiment, but is not limited thereto. The holding-down guide 301 may be a groove that is arranged on the sheet discharge guide 7 and extends in the X direction.

As for the recording medium 2 to be used in the recording apparatus 1, a wide variety of materials such as coated paper, non-coated paper, cloth, a vinyl chloride-based material, and a polyester-based material are used, and a thickness (grammage) and a thermal deformation characteristic of each material differ. Accordingly, the recording apparatus 1 includes adjustment mechanisms 303 that adjust a gap between the holding-down plate 302a and the sheet discharge guide 7 and a gap between the holding-down plate 302b and the sheet discharge guide 7 (see FIG. 3B).

In the configuration including the adjustment mechanism 303, the holding-down plate 302b is slidably disposed relative to the holding-down guide 301 via the adjustment mechanism 303. The adjustment mechanism 303 includes a member having a bolt portion protruding in a perpendicular direction from a guide surface (a surface supporting the recording medium 2) of the sheet discharge guide 7, and a nut that adjusts a height of the holding-down plate (302a, 302b) relative to the bolt portion.

The use of the adjustment mechanisms 303 enables heights of the holding-down plates 302a and 302b to be adjusted without being affected by a thickness or a thermal deformation characteristic of the recording medium 2. Hence, damage to recorded matter due to floating of the recording medium 2 and a jam of the recording medium 2 inside the fixing unit 100 can be reduced. The configuration of the adjustment mechanism 303 is not limited to the bolt and the nut. A known technique for adjusting a gap between the holding-down plate 302a and the sheet discharge guide 7 and a gap between the holding-down plate 302b and the sheet discharge guide 7 may be applied.

The present exemplary embodiment has been described based on the premise that the fixing unit 100 is moved up and down by the linking mechanism 200. However, the present exemplary embodiment is not limited thereto. The linking mechanism 200 may not be disposed. In such a case, a marking 304 serving as a mark indicating a sheet width is arranged on the sheet discharge guide 7 as illustrated in FIG. 3A, so that a user can adjust a position of the holding-down plate 302b by following the marking 304. The mark is not limited to the marking 304, and adhesive paper such as a sticker and a label may be used. Even in the configuration including the linking mechanism 200, a mark such as the marking 304 indicating a sheet width can be arranged near each of the holding-down guides 301.

Although the two holding-down guides 301 are arranged on the sheet discharge guide 7, the configuration is not limited thereto. One holding-down guide 301 or three or more holding-down guides 301 may be arranged. A holding-down guide 301 to be arranged on an upstream side in a conveyance direction may be arranged on the platen 6 instead of on the sheet discharge guide 7.

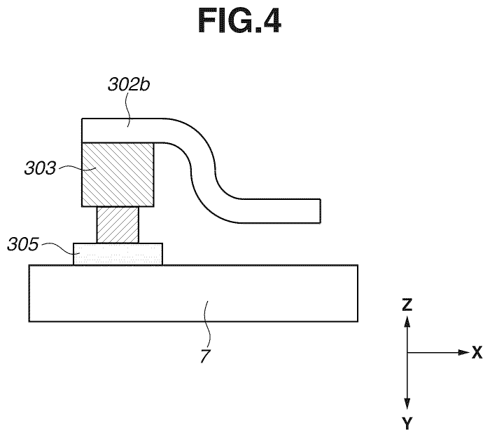

In addition, the holding-down plate 302b is not limited to the configuration in which the holding-down plate 302b slides relative to the holding-down guide 301. FIG. 4 illustrates a modification of the first exemplary embodiment. In the modification, a holding unit 305 is disposed. The holding unit 305 causes a sheet discharge guide 7 to hold a holding-down plate 302b. If the sheet discharge guide 7 is made of a magnetic material such as a steel plate, the holding unit 305 may be formed of a magnet. In another example, the holding unit 305 may be formed of an adhesive substance. In such a case, the holding unit 305 can adhere to the sheet discharge guide 7. The holding unit 305 may be formed in a hook shape engageable with a hole arranged on the sheet discharge guide 7. Accordingly, the arrangement of the holding unit 305 enables the holding-down plate 302b to be disposed at lower cost.

Furthermore, two or more holding-down plates 302b may be disposed. In a configuration in which a plurality of holding-down plate 302b is disposed, each of the holding-down plates 302b may be securely held to the sheet discharge guide 7 by the holding unit 305, or each of the holding-down plates 302b may be slidably disposed relative to the holding-down guide 301. Alternatively, a holding-down plate 302b securely held by the holding unit 305 and a holding-down plate 302b slidably disposed relative to the holding-down guide 301 may coexist.

The first exemplary embodiment has been described using a configuration in which the holding-down plate (302a, 302b) is disposed to the sheet discharge guide 7. A second exemplary embodiment is described using a configuration in which holding-down plates 302a and 302b are disposed to a chamber 101 of a fixing unit 100.

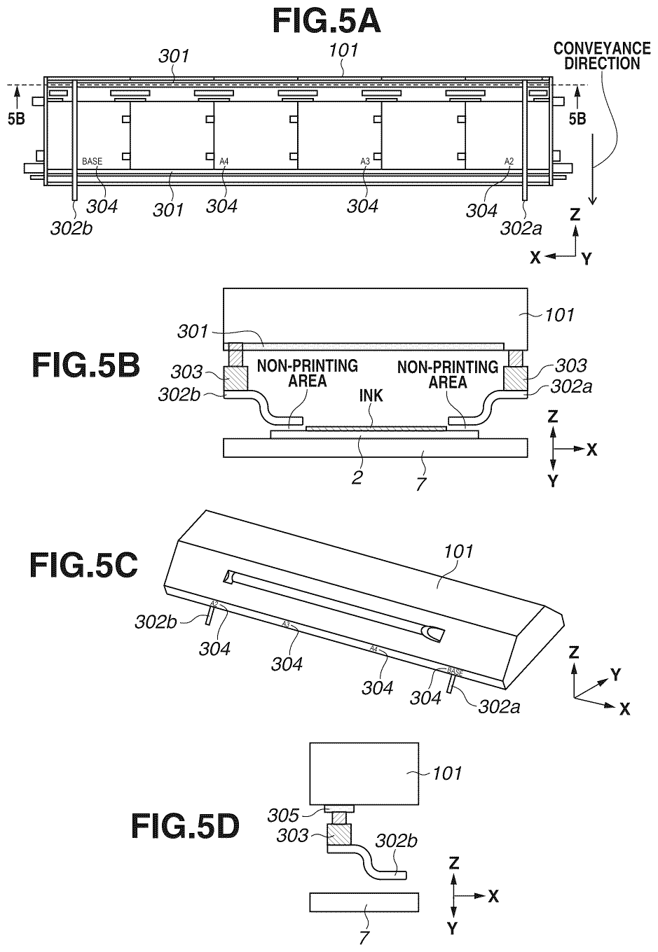

FIG. 5A is a bottom view of the fixing unit 100 as seen from below. In the present embodiment, a holding-down guide 301 and holding-down plates 302a and 302b are disposed on a bottom face of the chamber 101. A long an X direction (a width direction of a recording medium 2), the holding-down guide 301 is securely disposed to each of an upstream side (an upper side) and a downstream side (a lower side) of the chamber 101 in a conveyance direction.

Each of holding-down plates 302a and 302b extends in the conveyance direction such that the holding-down plates 302a and 302b bridge the two holding-down guides 301 which are respectively arranged upstream and downstream in the conveyance direction. The holding-down plate 302a is securely disposed on the right side (a side near an operation panel 28) when viewed from the front of a recording apparatus 1. On the other hand, the holding-down plate 302b is configured to be slidable in the X direction along the holding-down guide 301.

FIG. 5B is a schematic sectional view of the chamber 101 along the broken line 5B-5B of FIG. 5A, as seen from the conveyance direction. A configuration of the holding-down plates 302a and 302b is not limited to the configuration in which the holding-down plates 302a and 302b are directly disposed to the holding-down guide 301. As illustrated in FIG. 5B, each of the holding-down plates 302a and 302b may be disposed to the holding-down guide 301 via an adjustment mechanism 303.

Moreover, as illustrated in FIG. 5A, a marking 304 as a mark indicating a sheet width is arranged on the bottom face of the chamber 101, so that a position of the holding-down plate 302b can be adjusted more easily by being aligned with a width of the recording medium 2 after a user lifts the fixing unit 100 by a linking mechanism 200.

Alternatively, as illustrated in FIG. 5C, a marking 304 as a mark indicating a sheet width may be arranged on an outer surface of the fixing unit 100. A marking 304 may be arranged on a sheet discharge guide 7 as similar to the example illustrated in FIG. 3A. Thus, even in a case where the fixing unit 100 is not moved up or down since the linking mechanism 200 is not disposed, or the fixing unit 100 is in a fixing position, a position of the holding-down plate 302b can be adjusted more easily by being aligned with a width of the recording medium 2. The mark is not limited to the marking 304, and adhesive paper such as a sticker and a label may be used.

In the present exemplary embodiment, the holding-down guide 301 is securely disposed to the chamber 101. However, the arrangement of the holding-down guide 301 is not limited thereto. The holding-down guide 301 may be a groove that is arranged on the chamber 101 and extends in the X direction.

In addition, the holding-down plate 302b is not limited to the configuration in which the holding-down plate 302b slides relative to the holding-down guide 301. A holding unit 305 (see the first exemplary embodiment) that causes the chamber 101 to hold the holding-down plate 302b as illustrated in FIG. 5D may be applied.

Accordingly, the arrangement of the holding-down guide 301 and the holding-down plates 302a and 302b in the fixing unit 100 can prevent the holding-down plates 302a and 302b and the recording medium 2 from interfering with each other when the recording medium 2 is set on the sheet discharge guide 7. Moreover, in a case where the fixing unit 100 is configured to be moved up and down by the linking mechanism 200, the holding-down plates 302a and 302b can be set to hold down a recording medium 2 from above with movement of the fixing unit 100 to a fixing position. Hence, the recording medium 2 does not need to pass through a gap between the sheet discharge guide 7 and the holding-down plate 302a and a gap between the sheet discharge guide 7 and the holding-down plate 302b, and user operability can be more enhanced than that of the first exemplary embodiment.

Each of the first and second exemplary embodiments has been described using a configuration in which non-printing areas in two end portions of a recording medium 2 are held down by holding-down plates 302a and 302b. In a third exemplary embodiment, a description is given of a configuration that can be applied to edgeless printing in which ink is provided to a full surface of a recording medium 2.

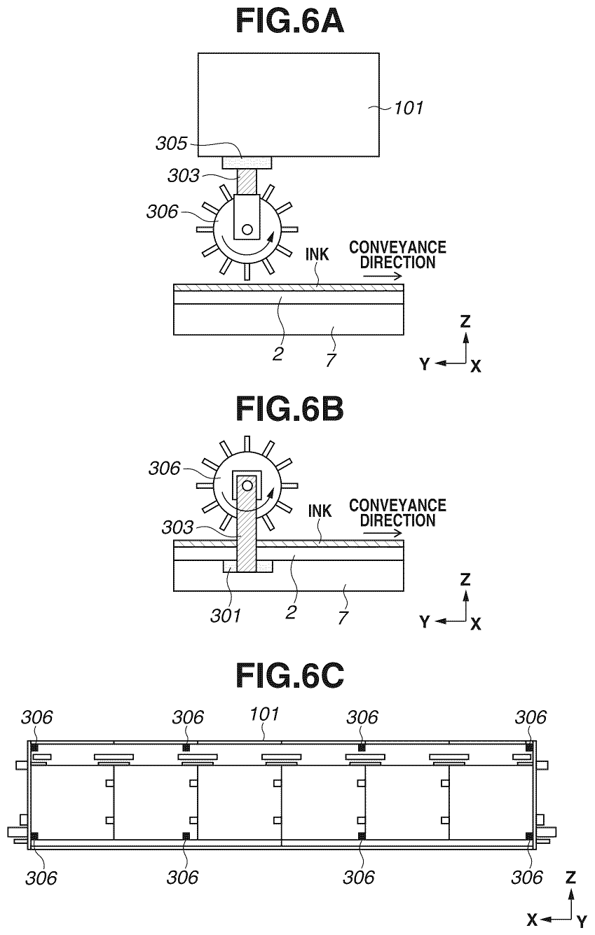

FIG. 6A is a schematic diagram illustrating a fixing unit 100 as seen from a width direction (an X direction) of a recording medium 2. In the present exemplary embodiment, the fixing unit 100 includes a spur roller 306 that contacts the recording medium 2 at a point while rotating in response to conveyance of the recording medium 2. The spur roller 306 is securely held to a chamber 101 by a holding unit 305 via an adjustment mechanism 303. FIG. 6B is a modification of FIG. 6A, and illustrates a configuration in which a spur roller 306 is securely held to a holding-down guide 301 (a sheet discharge guide 7) via an adjustment mechanism 303. Even in the configuration illustrated in FIG. 6B, the spur roller 306 may be held by the holding unit 305.

Since the spur roller 306 contacts the recording medium 2 at a point, a contact area between the spur roller 306 and the recording medium 2 is reduced. Thus, even in a case where the spur roller 306 contacts an ink provided area of the recording medium 2, the recording medium 2 can be held down without damage to recorded matter. Accordingly, even in a case where a recording medium 2 on which edgeless printing has been performed is thermally deformed, the recording medium 2 can be appropriately held down, thereby reducing damage to the recording medium 2 and a jam of the recording medium 2 inside the fixing unit 100. The adjustment mechanism 303 can include an urging member such as a spring. Such a configuration may enable a recording medium 2 to be held down in a stronger manner.

FIG. 6C is a bottom view of the chamber 101 as seen from below. In case where the spur roller 306 is disposed to the chamber 101, a plurality of spur rollers 306 may be disposed along an X direction as illustrated in FIG. 6C. In this case, the holding unit 305 described with reference to FIG. 6A is not necessarily indispensable, and the spur rollers 306 may be directly disposed to the chamber 101. The arrangement of the plurality of spur rollers 306 enables a recording medium 2 to be held down at a plurality of locations, and thus damage to the recording medium 2 and a jam of the recording medium 2 can be reduced even in a case where thermal deformation of the recording medium 2 is large. In addition, a user can be saved from having to adjust a sheet holding-down position depending on a width of a recording medium 2. The sheet holding-down position herein corresponds to a position of a spur roller 306 in the X direction. The arrangement of the plurality of spur rollers 306 can also be applied to the configuration illustrated in FIG. 6B in which the spur roller 306 is securely held to the holding-down guide 301 (the sheet discharge guide 7).

According to each of the exemplary embodiments, a recording apparatus that reduces recorded matter damage associated with deformation of the recording medium is provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-071972, filed Apr. 25, 2024, which is hereby incorporated by reference herein in its entirety.

What is claimed is:

1. A recording apparatus comprising:
a conveyance unit configured to convey a recording medium;
a recording head configured to record an image by ejecting ink to the recording medium conveyed by the conveyance unit;
a fixing unit configured to fix the ink onto the recording medium on which recording has been performed by the recording head;
a sheet discharge guide disposed opposite the fixing unit and configured to support the recording medium; and
a holding-down unit disposed between the fixing unit and the sheet discharge guide and configured to hold down the recording medium.

2. The recording apparatus according to claim 1, wherein the holding-down unit includes a holding-down plate configured to hold down the recording medium, and a holding-down guide configured to guide the holding-down plate.

3. The recording apparatus according to claim 2, wherein the holding-down plate extends in a conveyance direction of the recording medium.

4. The recording apparatus according to claim 2, wherein the holding-down plate is arranged on each of both ends in a direction intersecting with a conveyance direction of the recording medium.

5. The recording apparatus according to claim 1, wherein the holding-down unit includes a spur roller configured to hold down the recording medium.

6. The recording apparatus according to claim 5, wherein the spur roller contacts the recording medium at a point while rotating in response to conveyance of the recording medium.

7. The recording apparatus according to claim 2, comprising an adjustment mechanism configured to adjust a gap between the sheet discharge guide and the holding-down plate.

8. The recording apparatus according to claim 5, comprising an adjustment mechanism configured to adjust a gap between the sheet discharge guide and the spur roller.

9. The recording apparatus according to claim 1, wherein the holding-down unit is disposed to the sheet discharge guide.

10. The recording apparatus according to claim 1, wherein the holding-down unit is disposed to the fixing unit.
